(19) United States
(12) Patent Application Publication
(10) Pub. No.: US 2024/0273678 A1
(43) Pub. Date: Aug. 15, 2024

(54) UNMIXING IMAGE DATA

(71) Applicant: The Research Foundation for The State University of New York, Albany, NY (US)

(72) Inventors: Alex M. VALM, Albany, NY (US); Yunlong FENG, Slingerlands, NY (US)

(21) Appl. No.: 18/427,449

(22) Filed: Jan. 30, 2024

Related U.S. Application Data
(60) Provisional application No. 63/441,991, filed on Jan. 30, 2023.

(51) Int. Cl. G06T 5/50; G06T 7/00

(52) U.S. Cl. CPC G06T 5/50; G06T 7/00

(57) ABSTRACT

There is set forth herein, according to one embodiment, receiving a real image representing a target in which endmembers are present in unknown proportions; and searching and optimizing an abundance matrix space expressed in an unmixing formula that references together with the abundance matrix space, image information of the real image and an endmember spectral profile matrix that specifies spectral profiles for a set of differentiated reference endmembers; wherein as a result of the searching and optimizing the abundance matrix space, there is identified a set of unmixed real image endmembers and abundances associated to the unmixed real image endmembers.

### CROSS-REFERENCE TO RELATED APPLICATIONS

This application claims the benefit of priority to U.S. Provisional Patent Application No. 63/441,991, filed Jan. 30, 2023, titled, “Sparse Poisson Regression Approach for Unmixing Images of Fluorescently-Labeled Cells”, which is incorporated by reference herein in its entirety.

### GOVERNMENT RIGHTS STATEMENT

This invention was made with government support under the National Institute of Dental and Craniofacial Research Grant No. DE030927 and National Science Foundation Grant No. DMS2111080. The U.S. government has certain rights in the invention.

### BACKGROUND

Hyperspectral imaging can make use of information across the electromagnetic spectrum. In a multi-pixel hyperspectral image, respective pixels defining the image can include intensity information of multiple channels. Hyperspectral imaging finds use in multiple fields including biology, biomedical imaging, geology, astronomy, minerology, physics, surveillance, and additional fields.

### SUMMARY

There is set forth herein, according to one embodiment, receiving a real image representing a target in which endmembers are present in unknown proportions; and searching and optimizing an abundance matrix space expressed in an unmixing formula that references together with the abundance matrix space, image information of the real image and an endmember spectral profile matrix that specifies spectral profiles for a set of differentiated reference endmembers; wherein as a result of the searching and optimizing the abundance matrix space, there is identified a set of unmixed real image endmembers and abundances associated to the unmixed real image endmembers.

There is set forth herein, according to one embodiment, obtaining a plurality of multipixel reference images, wherein respective ones of the multipixel reference images are collected with a certain reference endmember of known identity present throughout a reference target, extracting endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix that specifies spectral profiles for a set of differentiated reference image endmembers; receiving a real image representing a target in which real image endmembers are present in unknown proportions; and searching and optimizing an abundance matrix space expressed in an unmixing formula that references together with the matrix space image information of the real image and the reference image endmember spectral profile matrix that specifies spectral profiles for the set of differentiated reference image endmembers; wherein as a result of the searching and optimizing the abundance matrix space, there is identified a set of unmixed real image endmembers and abundances associated to the real image endmembers.

There is set forth herein, according to one embodiment, obtaining a plurality of multipixel reference images, wherein respective ones of the multipixel reference images are collected with a certain reference endmember of known identity present throughout a reference target; for respective ones of the plurality of multipixel reference images, extracting endmember information that includes a spectral profile of a certain endmember, wherein the extracting endmember information includes searching and optimizing an endmember spectral profile vector space expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix that specifies spectral profiles for a set of differentiated reference image endmembers, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution; receiving a real image representing a target in which endmembers are present in unknown proportions; and unmixing the real image representing the target in dependence on the reference image endmember spectral profile matrix.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a hyperspectral data cube according to one embodiment.

FIG. 2 depicts a 3×3 window unmixed into the product of its endmember and abundance matrices according to one embodiment.

FIG. 3 depicts averages of RMSEs of the abundance matrices from NLS, S-NLS, SL-NLS, and SL-PRU with simulated data of AF514 and RRX with Poisson noise and SNR of 2 to 10 according to one embodiment.

FIG. 4 depicts averages of RMSEs of the abundance matrices estimated by NLS, S-NLS, SL-NLS, and SL-PRU from simulated data of AF555 and RRX with Poisson noise and SNR of 2 to 10 according to one embodiment.

FIG. 5 depicts a representation of simulated image pixels that contain two colocalized endmembers, either AF514 and RRX (highly uncorrelated endmembers, (Top row)) or AF555 and RRX (highly correlated endmembers (Bottom row)). In each row, the “Truth” matrix represents the ground truth starting simulation. Subsequent matrices represent the results of estimated abundances obtained from each of the unmixing methods that we considered. For each matrix, the 13 rows represent the 13 different endmembers used in the simulation and each column represents an independent pixel with varying intensity, scaled from 0-1. The color represents the mean abundance measure for each fluorophore from 1000 simulations of the same ground truth model after applying Poisson noise with SNR=5 to each pixel according to one embodiment.

FIG. 6 depicts a qualitative and quantitative comparison of least squares and SL-PRU unmixing on a real biological sample. A-F: Full field of view multi-spectral image of a dental plaque smear hedgehog structure after (A,C,E) least squares unmixing and (B,D,F) SL-PRU unmixing. Dashed boxes in (A) and (B) and in (C) and (D) indicate zoom area in C-D, and E-F respectively. Scale bars equal 100 μm (B), 25 μm, (D), 10 μm (F). G-H: Quantitative comparison of mean circularity measurement per cell for two coccoid-shaped cells in the plaque structure: Streptococcus (G) and Veillonella (H). Light grey bars=results from least squares unmixing, dark grey bars=results from SL-PU. Error bars represent 95% confidence intervals. ****=pᵢ0.001 Welch's t-test according to one embodiment.

FIG. 7 depicts quantitative comparison of mean circularity measurement per cell for two coccoid-shaped cells in the plaque structure: Streptococcus (A) and Veillonella (B). Light grey bars=results from least squares unmixing, dark grey bars=results from SL-PU. Error bars represent 95% confidence intervals. ****=pᵢ0.001 Welch's t-test

### DETAILED DESCRIPTION

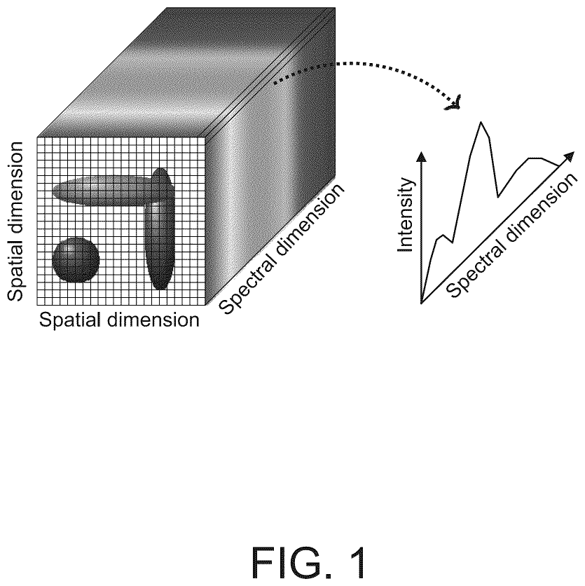

Embodiments herein recognize that many biological systems are composed of multiple interacting subcomponents, any of which may be labeled with fluorescent reporters to map their spatial location within cells and tissues. While some progress has been achieved in developing fluorescent dyes with narrow emission spectra, e.g., semiconductor nanocrystals or quantum dots, most widely used organic fluorophores, including fluorescent proteins, have broad excitation and emission spectra [1,18]. The inherent wide emission spectra of different fluorophores used in a single experiment lead to unavoidable overlap in spectral emission profiles and cross-talk between the recorded channels when samples are imaged with conventional bandpass filters. To overcome this limitation, fluorescence spectral imaging instrumentation and image analysis tools have been developed and applied to biological imaging. Spectral imaging microscopes collect fluorescence intensity information at every pixel in an image to construct a 3-dimensional data cube with spatial and spectral information from the sample as shown in FIG. 1.

Among existing biological spectral imaging analysis methods, spectral unmixing, which aims at extracting the spectral signature of each fluorophore from recorded images and gaining knowledge of each fluorophore's abundance in every pixel, has been widely utilized. In particular, linear unmixing approaches, especially utilizing the least squares framework, have been widely applied since these approaches make no underlying assumptions about the image data except that the signal recorded in the same pixel from multiple fluorophores adds linearly, i.e., no a priori knowledge about the sample is required. Linear unmixing separates each pixel linearly into the spectral signatures of the contributing fluorophores, called endmembers, and their contributions, called abundances. Due to physical considerations, both endmembers and abundances should satisfy the nonnegativity constraint. Given a spectral image Y∈ [symbol] ₊^{C×N} matrix with C channels and N pixels, M*∈ [symbol] ₊^{C×R} denoting as the endmember

$${A}^{*} ∈ {ℝ}_{+}^{R \times N}$$

matrix of the associated R fluorophores and the corresponding abundance matrix, such a linear relationship can be expressed as

$$Y = M * A * + ε ,$$

where [symbol] ∈ [symbol] ^{C×N} denotes an unknown noise matrix.

Least squares (linear) unmixing procedures are implemented by decomposing a spectral image matrix into an endmember matrix and an abundance matrix simultaneously while minimizing the data fidelity error measured by the squared error criterion, e.g., the sum of the squared residuals. Mathematically, it can be formulated as follows

$${min}_{M ≽ 0 , A ≽ 0} {‖ Y - MA ‖}_{F}^{2} ,$$

where ∥⋅∥_{F} denotes the Frobenius norm of a matrix, and M [symbol] 0 and A [symbol] 0 denote element-wise nonnegativity of the endmember matrix M and the abundance matrix A. In biological spectral imaging, it is frequently the case that reference spectral images that consist of only one fluorophore—and so only one endmember—in each image are available, which is also the scenario considered in this study. In such a case, least squares unmixing procedures can be carried out in a two-step way: first, each reference spectral image matrix is decomposed into the outer product of two vectors, i.e., the endmember and its abundances; then, with the extracted endmember information from the first step, the abundance matrix is estimated for the mixed image. Such a two-step approach is also considered in this study.

While least squares unmixing has been extensively studied and widely used in the spectral unmixing literature, its limitations are also well-recognized in the community. For instance, due to the involvement of matrix multiplication, least squares unmixing may not admit a unique solution, which leads to imprecise estimates of the abundances. In the literature, this problem is frequently addressed by imposing a certain penalty on A, which leads to

$${min}_{A ≽ 0} {‖ Y - MA ‖}_{F}^{2} + λΩ ( A ) ,$$

where λ>0 is a tuning parameter, Ω(A) denotes the penalty imposed on A, and M is assumed to be known from reference images. The penalty term λΩ(A) controls the complexity of the matrix space within which A is searched and thus may lead to a unique solution. Another disadvantage of the least squares unmixing approach lies in the use of the least squares error criterion, which originates from the maximum likelihood estimation when assuming Gaussian noise. In fact, the presence of purely Gaussian noise is rarely the case in biological spectral images. This is because the spectrum at each pixel of a biological fluorescence image corresponds to the photon counts recorded at every spectral channel and the uncertainties in these measurements can be better approximated by Poisson distributions rather than normal distributions (the so-called, photon shot noise); see e.g., [5]. Following this observation. Poisson regression approaches to spectral unmixing have been proposed in the literature; see e.g., [12, 18]. To date, existing applications of Poisson regression approaches to biological spectral unmixing comprise an active area of research, and the strengths and weaknesses of such approaches, when being compared with well-established least squares approaches, are yet to be fully elucidated.

Least squares approaches to spectral unmixing are implemented in a pixel-wise fashion, which requires no assumption regarding fluorophore distribution in the image. In biological spectral images, neighboring pixels are frequently similar in their fluorophore identities and abundances. This spatial correlation can be reflected as linear dependence between the corresponding abundances. As a result, the rank of the matrix formed by these abundance vectors may be limited, especially if we consider neighboring pixels in a small region. In addition, for a real biological spectral image, it is frequently the case that the recorded signal from any given pixel may only comprise one or a small number of endmembers, though, for the whole image, the number of involved endmembers may be far larger. However, least squares unmixing tends to treat all pixels and endmembers equally without taking such sparseness information into account, which may lead to imprecise abundance estimation when the number of contributing endmembers in any pixel is much smaller than that of the candidate pool across the entire image.

Here we address these gaps in knowledge and further take advantage of the prior information available regarding spectral images of fluorescently labeled cells by exploring a Poisson regression approach and by simultaneously seeking endmember-wise sparseness and low-rankness when estimating the abundances in a localized pattern. We propose in this paper a regularized sparse and low-rank Poisson regression approach (SL-PRU) to accurately estimate abundances in multiplex labeled images of cells. The proposed approach takes into account the non-Gaussian nature of the noise in the data and neighboring information, which are physically meaningful considerations in biological spectral imaging. To implement the low-rankness assumption of neighboring pixels, we make use of a sliding window technique, which allows us to consider the spectral signatures of adjacent pixels lying in the window. To make SL-PRU computationally tractable and to pursue further robustness, we consider convex relaxations of the penalty terms on the sparsity and the rank of the abundance matrix. It is noticed from our empirical studies that unregularized Poisson regression may lead to satisfying endmember extraction results. We thus suspend the penalty terms when implementing SL-PRU to extract endmembers in the first step from images with known fluorophore identities. In the second step, where SL-PRU is applied to unmix real biological images, we propose a constructive approach for tuning the parameters involved in the estimation without resorting to the unknown abundance matrix. We validate the proposed method on simulated spectral images and on real images of a microbial biofilm. The experimental results show that our proposed method can outperform existing approaches in biological imaging both quantitatively and qualitatively.

### 2 MATERIALS AND METHODS

### 2.1 Sample Preparation

E. coli K12 (ATCC 10798) cells were grown to the mid-log phase in Luria-Bertani LB Broth (Difco Laboratories, Inc.). E. coli cultures and dental plaque smears were fixed in 2% paraformaldehyde (EMS Diasum) for 1.5 hours at room temperature, then stored in 50% ethanol for 24 hours before FISH labeling. E. coli cells were labeled with the general bacteria probe, EUB338 (GCTGCCTCCCGTAGGAGT) conjugated to a fluorescent dye at the 5′ end (Thermofisher). Plaque smear samples were obtained through self-flossing from healthy volunteers after giving informed consent. The use of human subjects for this study was approved by the University at Albany Institutional Review Board (IRB). Plaque samples were labeled with previously validated taxon-specific FISH probes and acquired as multi-plane z-stack images.

### 2.2 Imaging and Pre-Processing

Images were acquired on Zeiss LSM 710 or LSM 880 confocal microscopes with 32 anode spectral detectors. Images were acquired with 488, 561, and 633 nm laser excitation and collected on the 32-anode spectral detector with 9.8 nm width spectral resolution in each channel. E. coli images were acquired as a single plane with a 63×1.4 NA objective. Plaque smear images and reference E. coli images were acquired as multi-plane Z-stack images with a 20×0.8 NA objective.

### 2.3 SL-PRU: The Proposed Unmixing Approach

Since the signal from multiple fluorophores adds linearly in a pixel, we can express the true photon counts as the sum of the endmembers weighted by their abundances. Considering that the recorded photon counts follow the Poisson distribution, a biological spectral image Y∈ [symbol] ₊^{C×N} with C channels and N pixels can be written as [13, 14, 16]

$$Y = Pois ( MA ) ,$$

where [symbol] ₊* denotes a nonnegative orthant in a k-dimensional Euclidean space, Pois(⋅) is element-wise Poisson probability distribution, M∈ [symbol] ₊^{C×R} represents the endmember matrix which consists of reference spectra of R fluorophores used for labeling, and A∈ [symbol] ₊^{R×N} denotes the abundance matrix.

To extract the m∈ [symbol] ₊^{C} endmember from a Yₘ∈ [symbol] ₊^{C×N} reference image, we maximize the likelihood of observing Yₘ∈ [symbol] ₊^{C×N} given m and the corresponding abundances a ∈ [symbol] ₊^{N}:

$$ℒ ( {Y}_{m} ; m , a ) = {\prod }_{c = 1}^{C} {\prod }_{n = 1}^{N} Pois ( {y}_{cn} ) = {\prod }_{c = 1}^{C} {\prod }_{n = 1}^{N} Pois ( {m}_{c} {a}_{n} ) ,$$

where m_{c} is the intensity of the endmember in channel c, aₙ is the corresponding abundance at pixel n, y_{cn} is observed intensity in channel c at pixel n of the reference image. To maximize [symbol] (Yₘ; m, a) is to minimize the negative log of, [symbol] (Yₘ; m, a):

$$- log ℒ ( {Y}_{m} ; m , a )$$

$$= - log ( {\prod }_{c = 1}^{C} {\prod }_{n = 1}^{N} {( {m}_{c} {a}_{n} )}^{{y}_{cn}} exp ( - {m}_{c} {a}_{n} ) )$$

$$= {{\sum }^{C}}_{c = 1} {{\sum }^{N}}_{n = 1} [ {m}_{c} {a}_{n} - {y}_{cn} log ( {m}_{c} {a}_{n} ) ] ,$$

where log denotes the natural logarithm. The endmember m can be obtained from a reference image Yₘ through the maximization likelihood estimation:

$${min}_{m ∈ {ℝ}_{+}^{C} , a ∈ {ℝ}_{+}^{N}} {{\sum }^{C}}_{c = 1} {{\sum }^{N}}_{n = 1} [ {m}_{c} {a}_{n} - {y}_{cn} log ( {m}_{c} {a}_{n} ) ] ,$$

which, in a compact form, is equivalent to Poisson Nonnegative Matrix Factorization (PNMF)

$${min}_{m ∈ {ℝ}_{+}^{C} , a ∈ {ℝ}_{+}^{N}} {1}_{C}^{T} [ {ma}^{T} - {Y}_{m} ∘ log ( {ma}^{T} ) ] {1}_{N} , \qquad ( 1 )$$

where 1_{C} and 1_{N} are vectors of length C and N whose entries are all 1 and ° denotes element-wise multiplication.

With endmembers extracted through reference images via (1), the abundance estimation of a spectral image that shares the same morphologies can be viewed as a nonnegative Poisson regression problem. Accordingly, in view of at least (1) and the described reference images, there is set forth herein obtaining a plurality of multipixel reference images, Ym, wherein respective ones of the multipixel reference images are collected with a certain reference endmember of known identity present throughout a reference target, extracting endmember information that includes a spectral profile of a certain reference image endmember, wherein the extracting endmember information includes searching and optimizing an endmember spectral profile vector space m expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix M that specifies spectral profiles for a set of differentiated reference image endmembers.

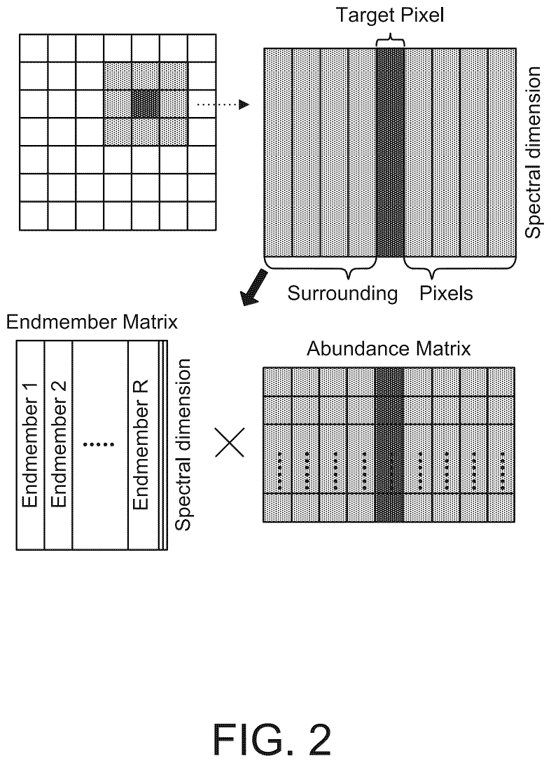

As both endmember-wise sparsity and spatial correlation properties rely on the homogeneity of a small area, we utilize a sliding 3×3 window that contains the spectra of the target pixel and spectra of its surrounding pixels for unmixing as shown in FIG. 2 [6]. In each window, we assume the contribution of only a few fluorophores which can be reflected as a limited number of endmembers with nonzero abundances. In the literature, the sparsity constraint is usually carried out via an [symbol] ₁ norm regularization that reduces the number of nonzero entries [7,15]. To impose endmember-wise sparsity on the abundance matrix A in a window, we apply the constraint among the rows of A which turns out to be the [symbol] _{2,1} norm where aᵣ denotes the r-th row of A and ∥⋅∥₂∥A∥_{2,1}=Σᵣ₌₁^{R}∥aᵣ∥₂ denotes the [symbol] ₂ norm [9]. The other property, spatial similarity of neighboring pixels, has also been [symbol] widely exploited for hyperspectral unmixing [6, 8, 17]. In this work, the spatial correlation is incorporated by imposing the low-rankness constraint on A. As a convex surrogate of the matrix rank, the nuclear norm ∥A∥, defined as the sum of its {σᵢ(A)}ᵢ₌₁^{rank(A)} singular values, is used.

With a slight abuse of notation, we denote in the following as a spectral window. The abundance matrix A can be estimated through the following sparse low-rank Poisson regression:

$${min}_{A ∈ {ℝ}_{+}^{R \times N}} {1}_{C}^{T} [ MA - Y ∘ log ( MA ) ] {1}_{N} + {λ}_{1} {‖ A ‖}_{*} + {λ}_{2} {‖ A ‖}_{2 , 1} , \qquad ( 2 )$$

where λ₁ and λ₂ are nonnegative parameters that balance the fidelity term, the penalty term on sparsity, and the penalty term on low-rankness.

Accordingly, in view of at least (1), (2) and reference images described herein, there is set forth herein according to one embodiment, obtaining a plurality of multipixel reference images, wherein respective ones of the multipixel reference images are collected with a certain reference endmember of known identity present throughout a reference target, extracting endmember information that includes a spectral profile m of a certain reference image endmember, wherein the extracting endmember information includes searching and optimizing an endmember spectral profile vector space expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix M that specifies spectral profiles for a set of differentiated reference image endmembers; receiving a real image Y representing a target in which real image endmembers are present in unknown proportions; and searching and optimizing an abundance matrix space A expressed in an unmixing formula (2) that references together with the abundance matrix space, image information of the real image and the reference image endmember spectral profile matrix that specifies spectral profiles for the set of differentiated reference image endmembers; wherein as a result of the searching and optimizing the abundance matrix space, there is identified a set of unmixed real image endmembers and abundances associated to the real image endmembers.

In one aspect, as set forth in at least (1) the endmember extraction formula can characterize noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution.

In one aspect, as set forth in at least (2), the unmixing formula can characterize real image noise of the real image as being distributed according to a real image Poisson noise distribution so that the set of unmixed real image endmembers and abundances associated to the unmixed real image endmembers are noise reduced in accordance with the real image Poisson noise distribution.

In one aspect, as set forth in at least (2), the unmixing formula can impose a rank constraint on the abundance matrix space, and wherein the unmixing formula imposes a sparseness constraint on the abundance matrix space.

In one aspect, as set forth in at least (2), the unmixing formula can impose a rank constraint on the abundance matrix space in favor of candidate matrices having respective ranks less than or equal to a specified rank, and wherein the rank constraint is expressed as a nuclear norm.

In one aspect, as set forth in at least (2), the unmixing formula can impose a rank constraint on the abundance matrix space, and wherein the unmixing formula imposes a sparseness constraint on the abundance matrix space.

In one aspect, as set forth in at least (2), the abundance matrix space can be defined by the row=fluorophores×column=pixels matrix space A, and the unmixing formula apply a sparseness constraint among the rows of A, wherein the sparseness constraint is provided by the [symbol] _{2,1} norm ∥A∥_{2,1}.

In one aspect, as set forth in at least (2), the abundance matrix space can be defined by the row=fluorophores×column=pixels matrix space, and the unmixing formula can include a constraint that penalizes searched for candidate matrixes in favor of candidate matrices featuring a specified level of sparseness in the fluorophores dimension.

In one aspect, at least in view of (2), embodiments herein recognize that rank and sparseness constraints improve the functioning of a computer in the performance of spectral unmixing digital image processing. In one aspect, embodiments herein recognize that constraining candidate matrices that are subject to searching for optimization of abundance matrix spaces results in economization of computing resources and faster computation times while also improving the quality of resulting images. See Section 3, herein.

In one aspect, as set forth at least in connection with the description accompanying (2), the unmixing formula references a sliding window matrix that defines the image information of the real image, wherein the sliding window matrix is a row-channel, column=pixels matrix, wherein the pixels dimension comprises a limited number of pixels of the real image, wherein the method includes performing iterations of searching and optimizing, and changing a location of the sliding window intermediate of iterations of the searching and optimizing.

In one aspect, at least in view of (2), embodiments herein recognize that the sliding window improves computer functioning and the quality of the resulting image not only because the sliding window facilitates use of the spatial information of the real image but also because the sliding window, due to the dependency of the pixel dimension of the abundance matrix space on the pixel dimension of the real image matrix, facilitates optimizations of the abundance matrix space with candidate matrices of qualifying low rank.

As convex relaxations of the [symbol] ₀ norm, i.e., the number of nonzero entries of a vector, and the rank function of a matrix, the [symbol] ₁ norm and the nuclear norm suffer from the influence of the magnitude [4, 11]. We thus use weighted formulations of nuclear norm and [symbol] _{2,1} norm to democratically penalize the nonzero entries:

$${‖ A ‖}_{{w}_{p} , *} = {{\sum }^{rank ( A )}}_{i = 1} {w}_{p , i} {σ}_{i} ( A ) ,$$

$$and$$

$${‖ {W}_{q} A ‖}_{2 , 1} = {{\sum }^{R}}_{r = 1} {w}_{q , r} {‖ {a}_{r} ‖}_{2} ,$$

$$where$$

$${w}_{p} = [ \begin{matrix}{w}_{p , 1} \\ {w}_{p , 2} \\ ⋮ \\ {w}_{p , rank ( A )}\end{matrix} ] , {W}_{q} = [ \begin{matrix}{w}_{q , 1} & 0 & … & 0 \\ 0 & {w}_{q , 2} & … & 0 \\ ⋮ & ⋮ & ⋱ & ⋮ \\ 0 & 0 & … & {w}_{q , R}\end{matrix} ] ,$$

and {w_{p,i}}ᵢ₌₁^{rank(A)}, {w_{q,r}}ᵣ₌₁^{R} are nonnegative weighting coefficients that will be determined later. As a result, we arrive at the following variant of the above regularized sparse and low-rank Poisson regression method:

$${min}_{A ∈ {ℝ}_{+}^{R \times N}} {1}_{C}^{T} [ MA - Y ∘ log ( MA ) ] {1}_{N} + {λ}_{1} {‖ A ‖}_{{w}_{p} , *} + {λ}_{2} {‖ {W}_{q} A ‖}_{2 , 1} , \qquad ( 3 )$$

In one aspect, as set forth in at least (3), the unmixing formula of (2) can impose a rank constraint on the abundance matrix space, wherein according to the rank constraint, weights are applied to candidate matrices in a manner to reduce a rank of a subset of candidate matrices evaluated by the searching and optimizing. In one aspect, as set forth in at least (3), the unmixing formula of (2) can increase the quality of a resulting image by the facilitation of additional candidate matrices satisfying the rank constraint.

An algorithm for solving which is detailed below.

### 2.4 Algorithms

Endmember extraction method (1) can be solved by multiplicative update algorithm which is a diagonally rescaled version of gradient descent. Denoting any variable X at the t-th, iteration as X^{(t)} and the maximum norm as ∥⋅∥_{∞}, the psuedocode of the multiplicative update algorithm is provided in Algorithm 1. The abundance vector a and the endmember vector m are initialized with random values that follow the standard uniform distribution U(0,1). At each iteration, the endmember vector is standardized by dividing by its maximum uniqueness. The algorithm stops when the relative change of the standardized endmember \tilde{m} between the (t−1)-th and the t-th iterations given by

$$\frac{{‖ {\tilde{m}}^{( t )} - {\tilde{m}}^{( t - 1 )} ‖}_{2}^{2}}{{‖ {\tilde{m}}^{( t - 1 )} ‖}_{2}^{2}}$$

Is less than a small threshold value.

We now turn to the discussion of the proposed algorithm for solving SL-PRU (3). Inspired by the work in [6], an alternating direction method of multipliers (ADMM) technique [3] is adopted in our study by first letting all elements of wₚ be equal to ensure the convexity of the low-rankness regularization term in SL-PRU (3). Similar to the work in [6], we introduce auxiliary variables V₁\ddot{ }∈ [symbol] ^{C×N}, V₂, V₃, V₁∈ [symbol] ^{R×N} and reformulate SL-PRU (3) as follows

$${min}_{U , {V}_{1} , {V}_{2} , {V}_{3} , {V}_{4}} {1}_{C}^{T} [ {V}_{1} - Y ∘ log ( {V}_{1} ) ] {1}_{N} + {λ}_{1} {‖ {V}_{2} ‖}_{{w}_{p} , *} + {λ}_{2} {‖ {W}_{q} {V}_{3} ‖}_{2 , 1} + {ℐ}_{{ℝ}_{+}} ( {V}_{4} ) , \qquad ( 4 )$$

$$s . t . {V}_{1} = MU , {V}_{2} = U , {V}_{3} = U , {V}_{4} = U ,$$

where [symbol] (⋅) is the indicator function which is zero if all the entries are nonnegative and infinity otherwise. Then we obtain the following augmented Lagrangian function for the optimization problem
Input: A reference image Yₘ∈ [symbol] ₊^{C×N}.
Output: The standardized endmember vector \tilde{m};
Initialization: a⁽⁰⁾, m⁽⁰⁾
repeat

$$⌈ \begin{matrix}{a}_{n}^{( t )} ← {\tilde{a}}_{n}^{( t - 1 )} \cdot ( \frac{{\sum }_{c} {y}_{cn} {\tilde{m}}_{c}^{( t - 1 )}}{{\tilde{m}}_{c}^{( t - 3 )} {\tilde{a}}_{n}^{( t - 1 )}} ) / ( {\sum }_{c} {\tilde{m}}_{c}^{( t - 1 )} ) ; \\ {m}_{c}^{( t )} ← {\tilde{m}}_{c}^{( t - 1 )} \cdot ( \frac{{\sum }_{n} {y}_{cn} {a}_{n}^{( t )}}{{\tilde{m}}_{c}^{( t - 1 )} {a}_{n}^{( t )}} ) / ( {\sum }_{n} {a}_{n}^{( t )} ) ; \\ {\tilde{m}}_{c}^{( t )} ← {m}_{c}^{( t )} / {‖ {m}^{( t )} ‖}_{∞} ; \\ {\tilde{a}}_{n}^{( t )} ← {a}_{n}^{( t )} \cdot {‖ {m}^{( t )} ‖}_{∞} ;\end{matrix}$$

until the stopping criterion is satisfied;
Algorithm 1: Multiplicative update algorithm for PNMF (1)
   (4):

$${ℒ}_{1} ( U , {V}_{1} , {V}_{2} , {V}_{3} , {V}_{4} , {D}_{1} , {D}_{2} , {D}_{3} , {D}_{4} ) = {1}_{C}^{⊤} \vert {V}_{1} - Y ∘ log ( {V}_{1} ) \vert {1}_{𝒩} + {λ}_{1} {‖ {V}_{2} ‖}_{{w}_{p} , *} + {λ}_{2} {‖ {W}_{q} {V}_{3} ‖}_{2 , 1} + {ℐ}_{{ℛ}_{+}} ( {V}_{4} ) + tr ( {D}_{1}^{⊤} ( {V}_{1} - MU ) ) + tr ( {D}_{2}^{⊤} ( {V}_{2} - U ) ) + tr ( {D}_{3}^{⊤} ( {V}_{3} - U ) ) + tr ( {D}_{4}^{⊤} ( {V}_{4} - U ) ) + \frac{μ}{2} ( {‖ MU - {V}_{1} ‖}_{F}^{2} + {‖ U - {V}_{2} ‖}_{F}^{2} + {‖ U - {V}_{3} ‖}_{F}^{2} + {‖ U - {V}_{4} ‖}_{F}^{2} ) . \qquad ( 5 )$$

Where D₁∈ [symbol] ^{C×N}, D₂, D₃, D₄∈ [symbol] ^{R×N} denote the Lagrange multipliers, tr( ) denotes the trace of a matrix, μ>0 is a Lagrange multiplier regularization parameter, and ∥⋅∥_{F} denotes the Frobenius norm. Denoting the identity matrix of size k×k as Iₖ and scaled Lagrange multipliers D₁′=Dᵢ/μ, i=1, 2, 3, 4, the augmented Lagrangian function [symbol] ₁ can be rewritten as

$${ℒ}_{2} ( U , V , D ) = {1}_{σ}^{⊤} [ {V}_{1} - Y ∘ log ( {V}_{1} ) ] {1}_{𝒩} + {λ}_{1} {‖ {V}_{2} ‖}_{{w}_{p} , *} + {λ}_{2} {‖ {W}_{q} {V}_{3} ‖}_{2.1} + {ℐ}_{{ℝ}_{+}} ( {V}_{4} ) + \frac{μ}{2} {‖ GU + BV - D ‖}_{F}^{2} , \qquad ( 6 )$$

$$Where$$

$$V = [ \begin{matrix}{V}_{1} \\ {V}_{2} \\ {V}_{3} \\ {V}_{4}\end{matrix} ] , D = [ \begin{matrix}{D}_{1}^{′} \\ {D}_{2}^{′} \\ {D}_{3}^{′} \\ {D}_{4}^{′}\end{matrix} ] , G = [ \begin{matrix}M \\ {I}_{B} \\ {I}_{R} \\ {I}_{E}\end{matrix} ] , B = - {I}_{C + 3 R} .$$

The proposed ADMM-type algorithm for solving SL-PRU sequentially optimizes (5) or (6) with respect to each variable while the other variables remain as the latest values. Optimizing [symbol] ₂ w.r.t. U gives

$${U}^{( t )} = {arg min}_{⋃} {ℒ}_{2} ( U , {V}^{( t - 1 )} , {D}^{( t - 1 )} ) = {( {M}^{⊤} M + 3 {I}_{R} )}^{- 1} [ \text{} {M}^{⊤} ( {V}_{1}^{( t - 1 )} + {D}_{1}^{′ ( t - 1 )} ) + {V}_{2}^{( t - 1 )} + {D}_{2}^{′ ( t - 1 )} + {V}_{3}^{( t - 1 )} + {D}_{3}^{′ ( t - 1 )} + {V}_{4}^{( t - 1 )} + {D}_{4}^{′ ( t - 1 )} ] . \qquad ( 7 )$$

Letting V₁′^{(t)}=MU^{(t)}−D₁′^{(t-1)}−1/μ, the optimization of [symbol] ₂ w.r.t. V₁ gives

$${V}_{1}^{( t )} - {arg min}_{{V}_{1}} {ℒ}_{2} ( {U}^{( t )} , [ \begin{matrix}{V}_{1} \\ {V}_{2}^{( t - 1 )} \\ {V}_{3}^{( t - 1 )} \\ {V}_{4}^{( t - 1 )}\end{matrix} ] , {D}^{( t - 1 )} ) = ( {V}_{1}^{′ ( t )} + \sqrt{{V}_{1}^{′ ( t )} ∘ {V}_{1}^{′ ( t )} + 4 Y / μ} ) / 2 , \qquad ( 8 )$$

where √ denotes the element-wise square root.

Denoting the singular value decomposition of U^{(t)}−D₂′^{(t-1)} as SₗΣ⁽ⁱ⁾Sᵣ^{T} the optimization w.r.t. V₂ gives

$${V}_{2}^{( t )} - {arg min}_{{V}_{2}} {ℒ}_{2} ( {U}^{( t )} , [ \begin{matrix}{V}_{1}^{( t )} \\ {V}_{2} \\ {V}_{3}^{( t - 1 )} \\ {V}_{4}^{( t - 1 )}\end{matrix} ] , {D}^{( t - 1 )} ) = {S}_{l} ⌈ sign ( {\sum }^{( t )} ) ∘ max \{ 0 , {\sum }^{( t )} - {λ}_{1} diag ( {w}_{p} ) / μ \} ⌉ {S}_{r}^{⊤} , \qquad ( 9 )$$

where sign (⋅) is the element-wise sign function, max{, ⋅} denotes the element-wise max function, and diag( ) creates a matrix with diagonal elements equal to the vector elements.

Denoting V_{3,r}^{(t)} as the r-th row of V₃^{(t)} and xᵣ^{(t)} as the r-th row of U^{(t)}−D₃′^{(t-1)} where r=1, . . . , R, each row of V₃ updated sequentially as

$${V}_{3 , r}^{( t )} = {arg min}_{{V}_{3 , r}} {ℒ}_{2} ( \begin{matrix}{U}^{( t )} , & [ \begin{matrix}{V}_{1}^{( t )} \\ {V}_{2}^{( t )} \\ {V}_{3 , 1}^{( t )} \\ ⋮ \\ {V}_{3 , r - 1}^{( t )} \\ {V}_{3 , r} \\ {V}_{3 , r + 1}^{( t - 1 )} \\ ⋮ \\ {V}_{3 , R}^{( t - 1 )} \\ {V}_{4}^{( t - 1 )}\end{matrix} ] & , {D}^{( t - 1 )}\end{matrix} ) = \frac{\begin{matrix}{x}_{r}^{( t )} max \{ {‖ {x}_{r}^{( t )} ‖}_{2} - \\ {λ}_{2} {w}_{q , r} / μ , 0 \}\end{matrix}}{\begin{matrix}max \{ {‖ {x}_{r}^{( t )} ‖}_{2} - \\ {λ}_{2} {w}_{q , r} / μ , 0 \} + \\ {λ}_{2} {w}_{q , r} / μ\end{matrix}} . \qquad ( 10 )$$

The optimization w.r.t. V₄ gives

$${V}_{4}^{( t )} = {arg min}_{{V}_{4}} {ℒ}_{2} ( \begin{matrix}{U}^{( t )} , & [ \begin{matrix}{V}_{1}^{( t )} \\ {V}_{2}^{( t )} \\ {V}_{3}^{( t )} \\ {V}_{4}^{( t )}\end{matrix} ] & , {D}^{( t - 1 )}\end{matrix} ) = max \{ {U}^{( t )} - {D}_{4}^{′ ( t - 1 )} , 0 \} . \qquad ( 11 )$$

The scaled Lagrange multipliers, D₁′, D₂′, D₃′, and D₄′, are updated as follows

$${D}_{1}^{′ ( t )} = {D}_{1}^{′ ( t - 1 )} - {MU}^{( t )} + {V}_{1}^{( t )} ,$$

$${D}_{i}^{′ ( t )} = {D}_{i}^{′ ( t - 1 )} - {U}^{( t )} + {V}_{1}^{( t )} ,$$

$$i = 2 , 3 , 4.$$

The stopping criteria adopted in the algorithm are based on the primal and dual residuals [3] rₚ and r_{d} given by

$${r}_{p} = {GU}^{( t )} + {BV}^{( t )} ,$$

$${r}_{d} = μ {G}^{⊤} B ( {V}^{( t )} - {V}^{( t - 1 )} ) .$$

that go to 0, respectively, as t→∞. The algorithm terminates whenever any of the [symbol] ₂ norm of rₚ or r_{d} is less than a small threshold value or some number of iterations is reached.

To enhance the performance of the algorithm, as done in [6], we also update the weights wₚ and W_{q} based on A^{(t)} at each iteration t as follows

$${w}_{p , i}^{( t )} = \frac{1}{{σ}_{i} ( {A}^{( t )} ) + ε} ,$$

$${w}_{q , r} = \frac{1}{{‖ {a}_{r}^{( l )} ‖}_{2} + ε} ,$$

where [symbol] >0 is assigned a small value to avoid singularities.

The pseudo-code of the proposed algorithm for solving SL-PRU (3) is presented in Algorithm 2.
Input: The data matrix Y∈ [symbol] ₊^{C×N}, and the endmember matrix M∈ [symbol] ₊^{C×R}
Output: The abundance matrix U;
Initialization: U⁰, V₁⁰, D₁⁰, i=1, 2, 3, 4;
Repeat

$$[ \begin{matrix}{U}^{( t )} ← {( {M}^{⊤} M + 3 {I}_{R} )}^{- 1} [ {M}^{⊤} ( {V}_{1}^{( t - 1 )} + {D}_{1}^{( t - 1 )} ) + {V}_{2}^{( t - 1 )} + {D}_{2}^{′ ( t - 1 )} + {V}_{3}^{( t - 1 )} + \\ {D}_{3}^{′ ( t - 1 )} + {V}_{4}^{( t - 1 )} + {D}_{4}^{′ ( t - 1 )} ] ; \\ V \text{?} ← ( V \text{?} + \sqrt{V \text{?} ∘ V \text{?} + 4 Y / μ} ) / 2 ; \\ {V}_{2}^{( t )} ← {S}_{t} \{ sign ( \sum ) ∘ max \{ 0 , \sum - {λ}_{r} diag ( {w}_{r} ) / μ \} ) {S}_{r}^{⊤} ; \\ {V}_{3 , r}^{( t )} ← ( {x}_{r}^{( t )} max \{ {‖ {x}_{r}^{( t )} ‖}_{2} - {λ}_{2} {w}_{q , *} / μ , 0 \} ) / max \{ {‖ {x}_{r}^{( t )} ‖}_{2} - {λ}_{2} {w}_{q , r} / μ , 0 \} + \\ {λ}_{2} {w}_{q , r} / μ ) , r = 1 , … , R ; \\ {V}_{4}^{( t )} ← max \{ {U}^{( t )} - {D}_{4}^{′ ( t - 1 )} , 0 \} ; \\ {D}_{1}^{′ ( t )} ← {D}_{1}^{′ ( t - 1 )} - {MU}^{( t )} + {V}_{1}^{( t )} ; \\ {D}_{i}^{′ ( t )} ← {D}_{i}^{′ ( t - 1 )} - {U}^{( t )} + {V}_{i}^{( t )} , \\ i = 2 , 3 , 4 ; \\ \text{?}\end{matrix}$$

$$\text{?} \text{indicates text missing or illegible when filed}$$

Until the stopping criteria are satisfied:
   Algorithm 2: The proposed ADMM-type algorithm for SL-PRU (3)

### 3 EXPERIMENTS AND RESULTS

The performance of our proposed approach, SL-PRU, is compared with the commonly used linear unmixing methods: nonnegative least squares approach (NLS) [19], sparse NLS (S-NLS) [2, 15], and sparse and low-rank NLS (SL-NLS) [6].

We carry out three different sets of experiments in which different types of spectral image data are used. In the first set of experiments, we unmix reference images of E. coli cells, in which every cell in the image contains a single endmember of known identity. Therefore, the performance of the different approaches in unmixing this data set can be compared by evaluating the proportion of the correct endmember assigned to each foreground pixel in the images while assuming all endmembers are also involved in each image. In our second set of experiments, we consider simulated spectral images, which are generated by using simulated abundance matrices and uncorrelated and correlated endmembers and by adding Poisson noise with different signal-to-noise ratios (SNRs). The root mean square errors (RMSEs) of the unmixing solutions from the different methods are evaluated for comparison. As a third set of experiments, we also evaluate the effectiveness of our proposed approach on real biological spectral images of labeled microbial biofilms and compare the results with NLS. Accordingly, there is set forth herein, obtaining a plurality of multipixel reference images, wherein respective ones of the multipixel reference images are collected with a certain reference endmember of known identity present throughout a reference target.

TABLE 1
Table 1: Optimal average proportions of endmembers estimated by NLS, NLS with sparsity constraint (S-NLS), NLS with
sparsity and low-rank constraints (SL-NLS), and Poisson regression with sparsity and low-rank constraints (SL-PRU).

| | AF488 | AF514 | TET | AF532 | AF546 | AF555 | RRX | AF568 | AF594 | AF647 | AF660 | AF680 | AF700 |
|---|---|---|---|---|---|---|---|---|---|---|---|---|---|
| NLS | 93.1% | 60.2% | 70.6% | 43.6% | 79.0% | 44.5% | 68.8% | 61.9% | 77.0% | 93.9% | 64.5% | 54.2% | 74.4% |
| S-NLS | 97.3% | 86.9% | 90.0% | 62.6% | 92.8% | 69.7% | 82.9% | 78.3% | 84.9% | 98.1% | 79.6% | 77.3% | 81.1% |
| SL-NLS | 98.7% | 96.4% | 93.2% | 72.1% | 96.8% | 76.8% | 91.2% | 89.2% | 91.3% | 99.0% | 86.7% | 85.4% | 87.7% |
| SL-PRU | 99.5% | 99.5% | 94.5% | 93.6% | 98.6% | 84.1% | 97.8% | 95.0% | 93.7% | 99.2% | 95.7% | 94.4% | 89.4% |

For all three experiments, the endmember spectra used for abundance estimation are extracted through PNMF (1) from known reference images. The tuning parameters λ₁ and λ₂ in (2) are chosen from the set {0, 10⁻³, 10⁻², 10⁻¹, 1, 10}, and u in Algorithm for solving SL-PRU.

### 3.1 Reference Images: Endmember Extraction and Unmixing

We first extract endmembers using PNMF (1) on thirteen reference images of labeled E. coli cells and apply SL-PRU to unmix them to estimate abundances. The standardized fluorometer measured spectra of thirteen endmembers against wavelength and the standardized endmember matrices can be extracted by the arithmetic mean method and PNMF.

Given an estimated abundance vector a=(a₁, a₂, . . . , aₙ)^{T} where aᵣ, r=1, . . . , R, denotes the estimated abundance of the r-th endmember of a pixel from a reference image being unmixed. Then, the proportion of the involved endmember in this pixel is defined as

$${Prop}_{{r}_{0}} ( a ) = \frac{{a}_{{r}_{0}}}{{\sum }_{r = 1}^{R} {a}_{r}} ,$$

where aᵣ₀ denotes the abundance of this endmember in the pixel. For a reference image, the average proportion (of the involved endmember) is defined as the average of such proportions across all pixels in this reference image. Note that for each reference image, only one endmember is involved. Therefore, the closer the average proportion is to 1, the better the estimated abundance vector.

With each tuning parameter for S-NLS or each pair of tuning parameters for SL-NLS or SL-PRU, we can obtain thirteen average proportions for all thirteen reference images. We choose the minimum of the thirteen average proportions for comparisons, since this represents the most conservative measure of unmixing accuracy. The tuning parameter values that reach the highest minimum of the thirteen average proportions obtained through each method are regarded as the optimal values. The average proportions of thirteen reference images obtained through each method: NLS, S-NLS, SL-NLS, and our proposed model SL-PRU with the optimal parameters are reported in Table 3.1. As shown in Table 3.1, our proposed method provides the highest average proportions among all the methods for all thirteen reference images.

### 3.2 Unmixing Simulated Spectral Images

Using the endmembers extracted from the same reference images as in the first set of experiments above, we simulate spectral images of size 3×3 pixels with two uncorrelated endmembers AF514 and RRX and two correlated ones, AF555 and RRX, respectively. The root mean square error criterion is used to compare the performance of different methods, where

$${RMSE}_{A} ( Å ) = \sqrt{\frac{{‖ A - Â ‖}_{F}^{2}}{NR}} ,$$

where A is the simulated abundance matrix that serves as the underlying truth and \hat{ }A the estimated abundance matrix.

### 3.2.1 Simulation 1: Uncorrelated Endmembers

The abundances of AF514 and RRX are generated from the uniform distribution U[0, 1] and the abundances of other endmembers are set to zero. Then the simulated spectral image is the multiplication of the generated abundance matrix and the endmember matrix. Poisson noise with nine SNRs ranging from 2 to 10 is added to the simulated data, and 1000 realizations of such simulated images are generated for each SNR.

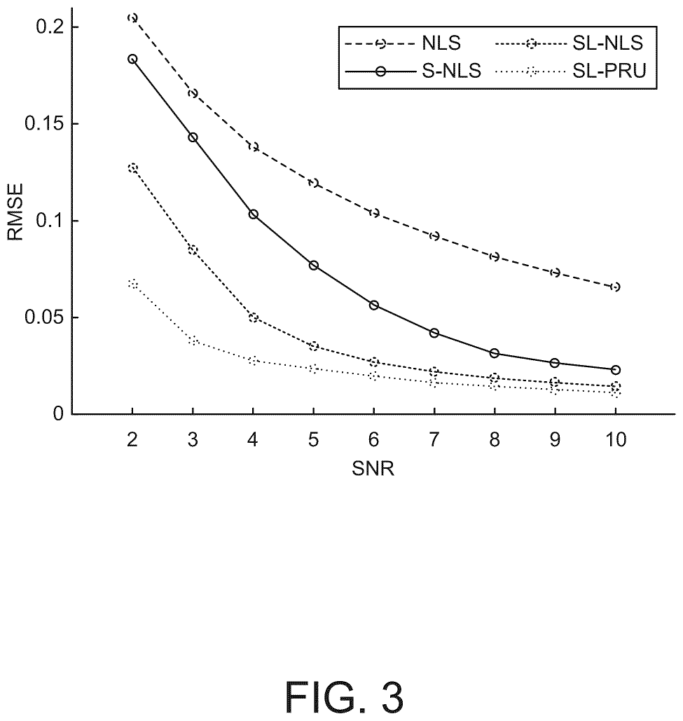

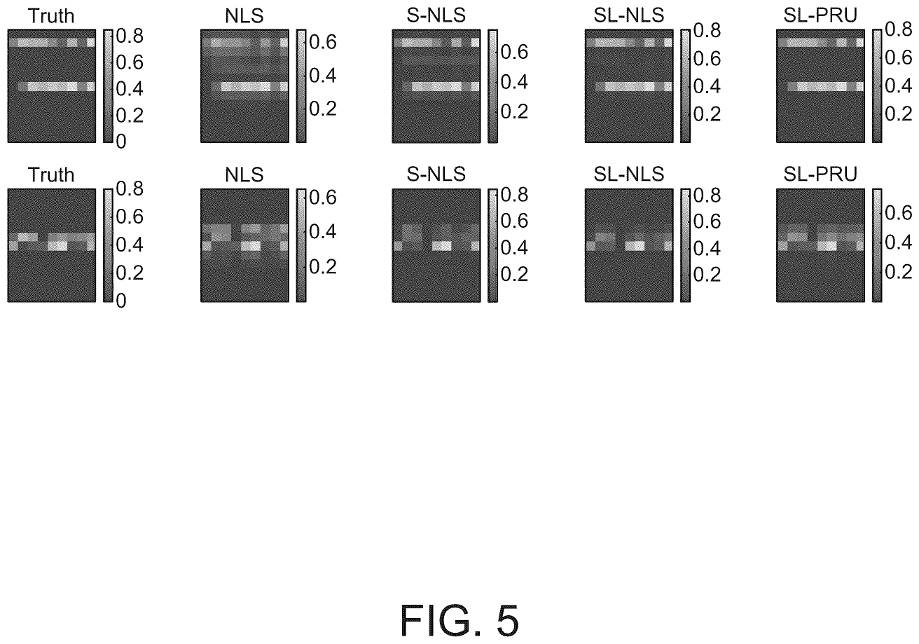

With the optimal parameter(s) being selected for the cases with different SNRs, the averaged RMSEs in 1,000 repetitions of all the unmixing methods under comparison are plotted in FIG. 3. In particular, when SNR is set to 5, the optimal average RMSE is obtained from SL-PRU with λ₁=0.1 and λ₂=1. Moreover, the average of the estimated abundance matrices for this scenario is plotted in the top row of FIG. 5.

From the reported experimental results in FIG. 3 and the top row of FIG. 5, it is observed that our proposed method can outperform other unmixing approaches under comparison here. For instance, as shown in FIG. 3, our proposed method gives the lowest RMSEs with different SNRs. And as illustrated in FIG. 5, the estimated average abundance matrix is more close to the true abundance matrix.

### 3.2.2 Simulation 2: Correlated Endmembers

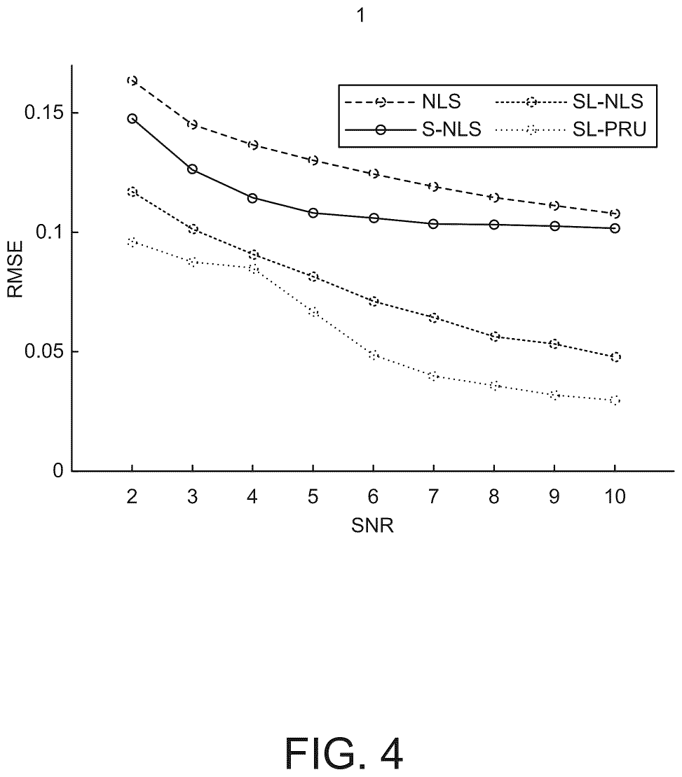

We next apply SL-PRU to unmix simulated spectral images with correlated endmembers AF555 and RRX under the same experimental setup as in Simulation I. Similarly, the averaged RMSEs from 1,000 repetitions of all the unmixing methods are plotted in FIG. 4, and when SNR is set to 5, the average of the estimated abundance matrices for this scenario is plotted in the bottom row of FIG. 5.

As shown in FIG. 4 and the bottom row of FIG. 5, SL-PRU also outperforms other unmixing approaches under comparison here. It is noted that the correlation between endmembers does have an impact on the performance of SL-PRU as well as other unmixing approaches, which coincides with our intuitive understanding of linear unmixing problems. However, the experiments carried out in our study also suggest that SL-PRU may outperform other unmixing approaches in unmixing spectral images with correlated endmembers, which could be an appealing feature of SL-PRU in some practical scenarios.

### 3.3 Unmixing Real Mixed Biological Images

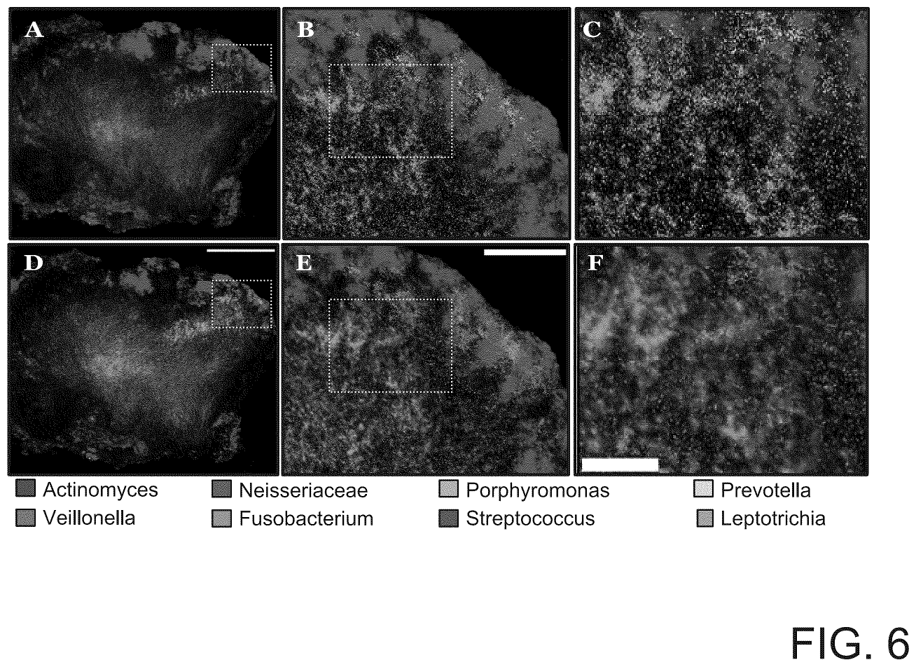

We next apply SL-PRU to unmix a real biological image with known fluorophore labels, but unknown spatial distributions and abundances. A dental plaque smear hedgehog structure was obtained from a healthy volunteer via dental flossing and labeled in a FISH experiment with taxon-specific probes for 8 different genera or families of bacteria, with each probe conjugated to a different fluorescent reporter. Reference spectra were obtained from images of separate populations of E. coli cells labeled with FISH probes conjugated to the eight fluorophores used in the plaque smear experiment and imaged under identical acquisition settings. Reference spectra were extracted using our Poisson endmember extraction procedure. The values for sparseness and low-rank tuning parameters were selected using a heuristic approach. Visual inspection of the unmixed plaque smear images was performed over the range of tuning parameters described above and values that maximized expected cell morphologies and minimized salt and pepper noise in the image were chosen for the final unmixing result (FIG. 6). To evaluate the performance of our SL-PRU on this real image, we performed a comparative, quantitative cellular morphological analysis against the unmixing result we obtained for the same image using the commercial microscope vendor's linear unmixing algorithm. One plaque smear image set was used for quantitative comparison. The full z-stack image was unmixed in Zeiss Zen software, with endmember reference spectra extracted from single E. coli cells in images acquired with the same settings as the plaque smear image. The same spectral image data set was then unmixed using our SL-PRU approach. One central z-plane from both images was extracted and used for quantitative comparison. Unmixed images were imported into ImageJ. The Streptococcus and Veillonella channels were segmented using an intensity threshold determined algorithmically using the same algorithm, either “Otsu” or “Triangle” for the Streptococcus channels and Veillonella channels respectively. Circularity analysis was performed on each segmented image, defined as

$$Circ = 4 π \frac{area}{{perimeter}^{2}} .$$

Streptococcus and Veillonella cells in the sample have characteristic, near-perfect spherical shapes. With this a priori information about these two labeled cells, we measured the circularity of these two cell populations in one central plane of the plaque smear image and found that SL-PRU improved the circularity measure by 16% for Streptococcus and 18.4% for Veillonella (FIG. 6). Lastly, we performed a line scan analysis on the same region of interest in the Streptococcus channel in both unmixed images and found that the SL-PRU approach generated an image with less noise and more identifiable cell boundaries than the commercial vendor least squares unmixing.

### 4 DISCUSSION

Multispectral imaging has allowed the visualization and quantification of large numbers of targets simultaneously within biological specimens. The linear model assumption behind spectral unmixing holds for most biological images acquired from specimens that are thin and therefore have minimal scattering effects and in which fluorescent tags label components. e.g., cells or macromolecules that are well separated in space, beyond the minimal Förster Resonance Energy Transfer distance. The least squares approach to unmixing is essentially a multi-output regression problem, which assumes a Gaussian noise distribution in the recorded signals; while it is known that the dominant noise source in fluorescence images follows a Poisson distribution. To better accommodate such a Poisson distribution, and to improve fidelity in fluorophore abundance estimation in the unmixing process by using prior information about our labeled samples, we have developed in this paper a sparse and low-rank Poisson (SL-PRU) approach to multispectral unmixing. Specifically, we considered a two-step approach where we first extract endmember information through reference images using unregularized Poisson regression and then learn the abundance information via the proposed regularized Poisson approach. In the case of multiplex labeled cells such as the microbial biofilm samples used here, we assume that while many dozens of fluorophores might be present in the sample, for any individual pixel, the number of fluorophores present approaches one. We demonstrated the effectiveness of the proposed approach through experimental results on model images and real biological samples reported above.

We believe that our SL-PRU unmixing approach will be generally applicable to a wide variety of image datasets of multi-plex, fluorescently labeled cells. As microscope detector technologies improve, and the need for extracting information from ever lower numbers of photons increases, the dominant noise source in fluorescence images of cells is expected to shift ever more toward the Poisson-distributed, physically unavoidable photon shot noise. Even as the number of labeled targets increases, the physical constraints of these targets, whether they be cells or macromolecules, limits their simultaneous occurrence in pixels in digitally recorded images, although we recognize that the finite resolution of the light microscope and the labeling of target molecules that are sufficiently small and diffusible together put limitations on the sparsity assumption in some situations. In implementing our low-rank penalty term, we used a sliding window approach and restricted our neighborhood size to 3×3 pixels. In general, the size of the sliding window should be dictated by the prior information available about the sample. e.g., the relative size of the labeled targets vs pixel dimensions in the image.

Finally, the effectiveness of the proposed sparse and low-rank Poisson approach has justified the importance of the low-rankness constraint in abundance estimation, which indicates the similarity of abundances of neighboring pixels. Note that such similarities, which agree with our intuitive understanding of spectral images, can be used to account for the spatial information among neighboring pixels. Recall that spectral images are three-way tensors and we unfold these tensor data into matrices

### 5 CONCLUSION

The existence of photon shot noise in biological fluorescence spectral images motivates us to address the unmixing problem through a Poisson approach instead of NLS. We also incorporate the spatial information by imposing sparsity and low-rankness constraints in a localized pattern. The unmixing results from both simulated data and real-world biological images demonstrate that our proposed approach SL-PRU can identify endmembers and estimate the corresponding abundances with increased accuracy over existing unmixing approaches.

Embodiments herein recognize that biological fluorescence microscopy has enabled the identification of multiple targets in complex samples. The accuracy in the unmixing result degrades (1) as the number of fluorophores used in any experiment increases and (2) as the signal-to-noise ratio in the recorded images decreases. Further, the availability of prior knowledge regarding the expected spatial distributions of fluorophores in images of labeled cells provides an opportunity to improve the accuracy of fluorophore identification and abundance. We propose a regularized sparse and low-rank Poisson unmixing approach (SL-PRU) to deconvolve spectral images labeled with highly overlapping fluorophores which are recorded in low signal-to-noise regimes. Firstly, SL-PRU implements multi-penalty terms when pursuing sparseness and spatial correlation of the resulting abundances in small neighborhoods simultaneously. Secondly, SL-PRU makes use of Poisson regression for unmixing instead of least squares regression to better estimate photon abundance. Thirdly, we propose a method to tune the SL-PRU parameters involved in the unmixing procedure in the absence of knowledge of the ground truth abundance information in a recorded image. By validating on simulated and real-world images, we show that our proposed method leads to improved accuracy in unmixing fluorophores with highly overlapping spectra.

FIG. 1 depicts a hyperspectral data cube and spectral intensity information at each pixel with a generalized biological image, in which most foreground pixels record fluorescent signal from only one cell but some pixels record overlapped signals from two or more cells.

FIG. 2 depicts a 3×3 window unmixed into the product of its endmember and abundance matrices.

FIG. 3 depicts averages of RMSEs of the abundances estimated by each of the unmixing methods that we considered from simulated images that contain colocalized AF514 and RRX with Poissonnoise and SNR of 2 to 10.

FIG. 4 depicts averages of RMSEs of the abundances estimated by each of the unmixing methods that we considered from simulated images that contain colocalized AF555 and RRX with Poissonnoise and SNR of 2 to 10.

FIG. 5 depicts a graphical representation of simulated image pixels that contain two colocalized endmembers, either AF514 and RRX (highly uncorrelated endmembers, (Top row)) or AF555 and RRX (highly correlated endmembers (Bottom row)). In each row, the “Truth” matrix represents the ground truth starting simulation. Subsequent matrices represent the results of estimated abundances obtained from each of the unmixing methods that we considered. For each matrix, the 13 rows represent the 13 different endmembers used in the simulation and each column represents an independent pixel with varying intensity, scaled from 0-1. The color represents the mean abundance measure for each fluorophore from 1000 simulations of the same ground truth model after applying Poissonnoise with SNR=5 to each pixel.

FIG. 6 depicts a qualitative and quantitative comparison of least squares and SL-PRU unmixing on a real biological sample. A-F: Multi-spectral image of a dental plaque smear hedgehog structure after (A-C) least squares unmixing and (D-F) SL-PRU unmixing. Dashed boxes in (A) and (B) and in (C) and (D) indicate zoom area in C-D, and E-F respectively. Scale bars equal 100 μm (B), 25 μm, (D), 10 μm (F).

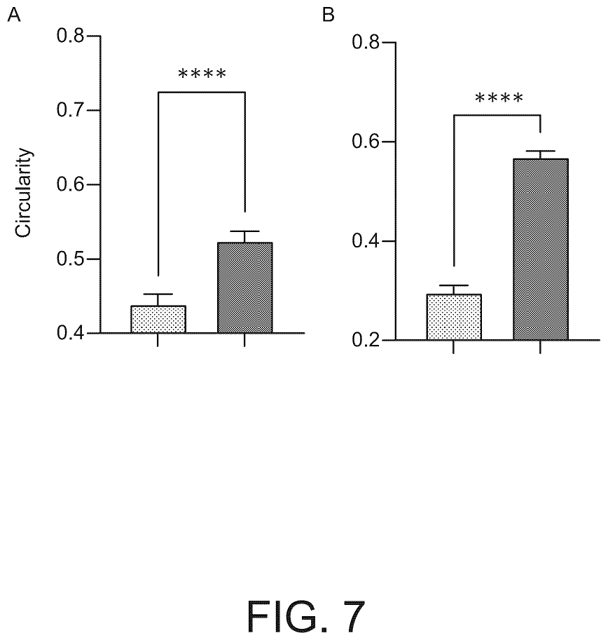

FIG. 7 depicts quantitative comparison of mean circularity measurement per cell for two coccoid-shaped cells in the plaque structure: Streptococcus (A) and Veillonella (B). Light grey bars=results from least squares unmixing, dark grey bars=results from SL-PU. Error bars represent 95% confidence intervals. ****=pᵢ0.001 Welch's t-test

A small sample of combinations set forth herein include the following. A1. A method for performance of spectrally unmixing comprising: receiving a real image representing a target in which endmembers are present in unknown proportions; and searching and optimizing an abundance matrix space expressed in an unmixing formula that references together with the abundance matrix space, image information of the real image and an endmember spectral profile matrix that specifies spectral profiles for a set of differentiated reference endmembers; wherein as a result of the searching and optimizing the abundance matrix space, there is identified a set of unmixed real image endmembers and abundances associated to the unmixed real image endmembers. A2. The method of A1, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution. A3. The method of A1, wherein the abundance matrix space is defined by the row=fluorophores×column=pixels matrix space, and wherein unmixing formula includes a constraint that penalizes searched for candidate matrixes in favor of candidate matrices featuring a specified level of sparseness in the fluorophores dimension. A4. The method of A1, wherein the abundance matrix space is defined by the row-fluorophores×column=pixels matrix space A. and wherein the unmixing formula applies a sparseness constraint among the rows of A, wherein the sparseness constraint is provided by the [symbol] _{2,1} norm ∥A∥_{2,1}. A5. The method of A1, wherein the unmixing formula imposes a rank constraint on the abundance matrix space, and wherein the unmixing formula imposes a sparseness constraint on the abundance matrix space. A6. The method of A1, wherein the unmixing formula imposes a rank constraint on the abundance matrix space, and wherein according to the rank constraint, weights are applied to candidate matrices in a manner to reduce a rank of a subset of candidate matrices evaluated by the searching and optimizing. A7. The method of A1, wherein the unmixing formula imposes a rank constraint on the abundance matrix space in favor of candidate matrices having respective ranks less than or equal to a specified rank, and wherein the rank constraint is expressed as a nuclear norm. A8. The method of A1, wherein the unmixing formula references a sliding window matrix that defines the image information of the real image, wherein the sliding window matrix is a row=channel, column=pixels matrix, wherein the pixels dimension comprises a limited number of pixels of the real image, wherein the method includes performing iterations of searching and optimizing, and changing a location of the sliding window intermediate of iterations of the searching and optimizing. A9. The method of A1, wherein the method includes obtaining a plurality of multipixel reference images, wherein respective ones of the multipixel reference images are collected with a certain reference endmember of known identity present throughout a reference target; extracting, for respective ones of the plurality of multipixel reference images, endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image, wherein as a result of performing the extracting endmember information for the respective multipixel reference images, there is produced the endmember spectral profile matrix that specifies spectral profiles for the set of reference endmembers. A10. The method of A1, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution, wherein the method includes obtaining a plurality of multipixel reference images, wherein respective ones of the multipixel reference images are collected with a certain reference endmember of known identity present throughout a reference target; extracting, for respective ones of the plurality of multipixel reference images, endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image, wherein as a result of performing the extracting endmember information for the respective multipixel reference images, there is produced the endmember spectral profile matrix that specifies spectral profiles for the set of reference endmembers, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula imposes a rank constraint on the abundance matrix space, wherein according to the rank constraint, weights are applied to candidate matrices in a manner to reduce a rank of a subset of candidate matrices evaluated by the searching and optimizing, wherein the abundance matrix space is defined by the row-fluorophores×column=pixels matrix space A. and wherein the unmixing formula applies a sparseness constraint among the rows of A, wherein the sparseness constraint is provided by the [symbol] _{2,1} norm ∥A∥_{2,1}, and wherein the unmixing formula references a sliding window matrix that defines the image information of the real image, wherein the sliding window matrix is a row=channel, column=pixels matrix, wherein the pixels dimension comprises a limited number of pixels of the real image, wherein the method includes performing iterations of searching and optimizing, and changing a location of the sliding window intermediate of iterations of the searching and optimizing. B1. A method for performance of spectrally unmixing comprising: obtaining a plurality of multipixel reference images, wherein respective ones of the multipixel reference images are collected with a certain reference endmember of known identity present throughout a reference target; for respective ones of the plurality of multipixel reference images, extracting endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix that specifics spectral profiles for a set of differentiated reference image endmembers; receiving a real image representing a target in which real image endmembers are present in unknown proportions; and searching and optimizing an abundance matrix space expressed in an unmixing formula that references together with the abundance matrix space, image information of the real image and the reference image endmember spectral profile matrix that specifics spectral profiles for the set of differentiated reference image endmembers; wherein as a result of the searching and optimizing the abundance matrix space, there is identified a set of unmixed real image endmembers and abundances associated to the real image endmembers. B2. An apparatus comprising: a microscope that includes multiple spectral detectors, wherein the apparatus is operative for performing the method of B1, wherein the apparatus is operative for performing the obtaining, with use of the microscope, the plurality of multipixel reference images, wherein respective ones of the multipixel reference images are collected with a certain reference endmember of known identity present throughout the reference target; wherein the apparatus is further operative for performing the receiving, with use of the microscope that includes multiple spectral detectors, the real image representing the target, in which real image endmembers are present in unknown proportions; wherein the apparatus is further operative for performing the searching and optimizing the abundance matrix space expressed in an unmixing formula that references together with the abundance matrix space, image information of the real image and the reference image endmember spectral profile matrix that specifics spectral profiles for the set of differentiated reference image endmembers, and wherein identical acquisition settings for the microscope characterize the obtaining and the receiving. B3. The method of B1, wherein the unmixing formula imposes a rank constraint on the abundance matrix space. B4. The method of B1, wherein the unmixing formula imposes a sparseness constraint on the abundance matrix space. B5. The method of B1, wherein the endmember extraction formula characterizes noise of respective ones of the multipixel reference images such that an endmember vector of the reference image endmember spectral profile matrix is noise reduced. B6. The method of B1, wherein the endmember extraction formula characterizes noise of respective ones of the multipixel reference images according to a reference image Poisson noise distribution pattern so that an endmember vector of the reference image endmember spectral profile matrix is noise reduced according to the reference image Poisson noise distribution pattern. −B7. The method of B1, wherein the unmixing formula characterizes noise of the real image according to a real image Poisson noise distribution pattern so that the identified set of unmixed real image endmembers and abundances are noise reduced according to the Poisson noise distribution pattern. B8. The method of B1, wherein the certain reference endmember of known identity is a fluorophore reference endmember, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution. B9. The method of B1, wherein the certain reference endmember of known identity is a fluorophore reference endmember, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula imposes a rank constraint on the abundance matrix space, wherein according to the rank constraint, weights are applied to candidate matrices in a manner to reduce a rank of a subset of candidate matrices evaluated by the searching and optimizing, wherein the abundance matrix space is defined by the row-fluorophores×column=pixels matrix space A. and wherein the unmixing formula applies a sparseness constraint among the rows of A, wherein the sparseness constraint is provided by the [symbol] _{2,1} norm ∥A∥_{2,1}, and wherein the unmixing formula references a sliding window matrix that defines the image information of the real image, wherein the sliding window matrix is a row-Channel, column=pixels matrix, wherein the pixels dimension comprises a limited number of pixels of the real image, wherein the method includes performing iterations of searching and optimizing, and changing a location of the sliding window intermediate of iterations of the searching and optimizing, and wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution. C1. A method for performance of spectrally unmixing comprising: obtaining a plurality of multipixel reference images, wherein respective ones of the multipixel reference images are collected with a certain reference endmember of known identity present throughout a reference target; for respective ones of the plurality of multipixel reference images, extracting endmember information that includes a spectral profile of a certain endmember, wherein the extracting endmember information includes searching and optimizing an endmember spectral profile vector space expressed in an endmember extraction formula that references together with the endmember spectral profile vector space, image information of a respective multipixel reference image; wherein as a result of performing the extracting endmember information for the respective multipixel reference images, there is produced a reference image endmember spectral profile matrix that specifics spectral profiles for a set of differentiated reference image endmembers, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution; receiving a real image representing a target in which endmembers are present in unknown proportions; and unmixing the real image representing the target in dependence on the reference image endmember spectral profile matrix.

### REFERENCES

1. Barroso. Quantum dots in cell biology. Journal of Histochemistry and Cytochemistry, 59(3):237-251, 2011.
2. J. M. Bioucas-Dias and M. A. Figueiredo. Alternating direction algorithms for constrained sparse regression: Application to hyperspectral unmixing. In 2010 2nd Workshop on Hyperspectral Image and Signal Processing: Evolution in Remote Sensing, pages 1-4. IEEE, 2010.
3. S. Boyd, N. Parikh, E. Chu, B. Peleato, J. Eckstein, et al. Distributed optimization and statistical learning via the alternating direction method of multipliers. Foundations and Trends@ in Machine Learning, 3(1): 1-122, 2011.
4. E. J. Candes, M. B. Wakin, and S. P. Boyd. Enhancing sparsity by reweighted £1 minimization. Journal of Fourier Analysis and Applications, 14(5): 877-905, 2008.
5. P. Coates. Photomultiplier noise statistics. Journal of Physics D: Applied Physics, 5(5): 915, 1972.
6. P. V. Giampouras, K. E. Themelis, A. A. Rontogiannis, and K. D. Koutroumbas. Simultaneously sparse and low-rank abundance matrix estimation for hyperspectral image unmixing. IEEE Transactions on Geoscience and Remote Sensing, 54(8):4775-4789, 2016.
7. M.-D. lordache, J. M. Bioucas-Dias, and A. Plaza. Sparse unmixing of hyperspectral data. IEEE Transactions on Geoscience and Remote Sensing, 49(6): 2014-2039, 2011.
8. M.-D. lordache, J. M. Bioucas-Dias, and A. Plaza. Total variation spatial regularization for sparse hyperspectral unmixing. IEEE Transactions on Geoscience and Remote Sensing, 50(11):4484-4502, 2012.
9. M.-D. lordache, J. M. Bioucas-Dias, and A. Plaza. Collaborative sparse regression for hyperspectral unmixing. IEEE Transactions on Geoscience and Remote sensing, 52(1): 341-354, 2013.
10. D. Lee and H. S. Seung. Algorithms for non-negative matrix factorization. Advances in Neural Information processing Systems, 13, 2000.
11. C. Lu, J. Tang, S. Yan, and Z. Lin. Generalized nonconvex nonsmooth low-rank minimization. In Proceedings of the IEEE Conference on Computer Vision and Pattern Recognition, pages 4130-4137, 2014.
12. R. Neher and E. Neher. Optimizing imaging parameters for the separation of multiple labels in a fluorescence image. Journal of Microscopy, 213(1):46-62, 2004.
13. R. A. Neher, M. Mitkovski, F. Kirchhoff, E. Neher, F. J. Theis, and A. Zeug. Blind source separation techniques for the decomposition of multiply labeled fluorescence images. Biophysical Journal, 96(9): 3791-3800, 2009.
14. D. Novo, G. Gregori, and B. Rajwa. Generalized unmixing model for multispectral flow cytometry utilizing nonsquare compensation matrices. Cytometry Part A, 83(5):508-520, 2013.
15. B. J. Rossetti, S. A. Wilbert, J. L. Mark Welch, G. G. Borisy, and J. G. Nagy. Semi-blind sparse affine spectral unmixing of autofluorescence-contaminated micrographs. Bioinformatics, 36(3):910-917, 2020.
16. J. Xu, J. Bobin, A. de Vismes Ott, and C. Bobin. Sparse spectral unmixing for activity estimation in ‘)’-ray spectrometry applied to environmental measurements. Applied Radiation and Isotopes, 156:108903, 2020.
17. X. Zhang, Y. Sun, J. Zhang, P. Wu, and L. Jiao. Hyperspectral unmixing via deep convolutional neural networks. IEEE Geoscience and Remote Sensing Letters, 15(11): 1755-1759, 2018.
18. T. Zimmermann. Spectral imaging and linear unmixing in light microscopy. Microscopy Techniques, pages 245-265, 2005.
19. Zimmermann, Timo. Spectral imaging and linear unmixing in light microscopy. Advances in Biochemical Engineering/Biotechnology, 95:245-265, 2005.

It should be appreciated that all combinations of the foregoing concepts and additional concepts discussed in greater detail below (provided such concepts are not mutually inconsistent) are contemplated as being part of the subject matter disclosed herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely exemplary. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first.” “second.” and “third.” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112(f) unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to #10%, such as less than or equal to ±5%, such as less than or equal to #2%, such as less than or equal to ±1%, such as less than or equal to ±0.5%, such as less than or equal to ±0.2%, such as less than or equal to ±0.1%, such as less than or equal to #0.05%. If used herein, the terms “substantially”, “approximately”, “about”, “relatively.” or other such similar terms may also refer to no fluctuations, that is, ±0%. It is contemplated that numerical values, as well as other values that are recited herein can be modified by the term “about”, whether expressly stated or inherently derived by the discussion of the present disclosure. Further, any description of a range herein can encompass all subranges.

The terms “connect.” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description, but is only limited by the scope of the appended claims.

What is claimed is:

1. A method for performance of spectrally unmixing comprising:
receiving a real image representing a target in which endmembers are present in unknown proportions; and
searching and optimizing an abundance matrix space expressed in an unmixing formula that references together with the abundance matrix space, image information of the real image and an endmember spectral profile matrix that specifies spectral profiles for a set of differentiated reference endmembers;
wherein as a result of the searching and optimizing the abundance matrix space, there is identified a set of unmixed real image endmembers and abundances associated to the unmixed real image endmembers.

2. The method of claim 1, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution.

3. The method of claim 1, wherein the abundance matrix space is defined by the row-fluorophores×column-pixels matrix space, and wherein unmixing formula includes a constraint that penalizes searched for candidate matrixes in favor of candidate matrices featuring a specified level of sparseness in the fluorophores dimension.

4. The method of claim 1, wherein the abundance matrix space is defined by the row-fluorophores×column=pixels matrix space A, and wherein the unmixing formula applies a sparseness constraint among the rows of A, wherein the sparseness constraint is provided by the [symbol] _{2,1} norm ∥A∥_{2,1}.

5. The method of claim 1, wherein the unmixing formula imposes a rank constraint on the abundance matrix space, and wherein the unmixing formula imposes a sparseness constraint on the abundance matrix space.

6. The method of claim 1, wherein the unmixing formula imposes a rank constraint on the abundance matrix space, and wherein according to the rank constraint, weights are applied to candidate matrices in a manner to reduce a rank of a subset of candidate matrices evaluated by the searching and optimizing.

7. The method of claim 1, wherein the unmixing formula imposes a rank constraint on the abundance matrix space in favor of candidate matrices having respective ranks less than or equal to a specified rank, and wherein the rank constraint is expressed as a nuclear norm.

8. The method of claim 1, wherein the unmixing formula references a sliding window matrix that defines the image information of the real image, wherein the sliding window matrix is a row=channel, column=pixels matrix, wherein the pixels dimension comprises a limited number of pixels of the real image, wherein the method includes performing iterations of searching and optimizing, and changing a location of the sliding window intermediate of iterations of the searching and optimizing.

9. The method of claim 1, wherein the method includes obtaining a plurality of multipixel reference images, wherein respective ones of the multipixel reference images are collected with a certain reference endmember of known identity present throughout a reference target; extracting, for respective ones of the plurality of multipixel reference images, endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image, wherein as a result of performing the extracting endmember information for the respective multipixel reference images, there is produced the endmember spectral profile matrix that specifies spectral profiles for the set of reference endmembers.

10. The method of claim 1, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution, wherein the method includes obtaining a plurality of multipixel reference images, wherein respective ones of the multipixel reference images are collected with a certain reference endmember of known identity present throughout a reference target; extracting, for respective ones of the plurality of multipixel reference images, endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image, wherein as a result of performing the extracting endmember information for the respective multipixel reference images, there is produced the endmember spectral profile matrix that specifies spectral profiles for the set of reference endmembers, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula imposes a rank constraint on the abundance matrix space, wherein according to the rank constraint, weights are applied to candidate matrices in a manner to reduce a rank of a subset of candidate matrices evaluated by the searching and optimizing, wherein the abundance matrix space is defined by the row=fluorophores×column=pixels matrix space A, and wherein the unmixing formula applies a sparseness constraint among the rows of A, wherein the sparseness constraint is provided by the [symbol] _{2,1} norm ∥A∥_{2,1}, and wherein the unmixing formula references a sliding window matrix that defines the image information of the real image, wherein the sliding window matrix is a row=channel, column=pixels matrix, wherein the pixels dimension comprises a limited number of pixels of the real image, wherein the method includes performing iterations of searching and optimizing, and changing a location of the sliding window intermediate of iterations of the searching and optimizing.

11. A method for performance of spectrally unmixing comprising:
obtaining a plurality of multipixel reference images, wherein respective ones of the multipixel reference images are collected with a certain reference endmember of known identity present throughout a reference target;
for respective ones of the plurality of multipixel reference images, extracting endmember information that includes a spectral profile of a certain reference image endmember, wherein the extracting endmember information includes searching and optimizing an endmember spectral profile vector space expressed in an endmember extraction formula that references together with the endmember spectral profile vector space, image information of a respective multipixel reference image;
wherein as a result of performing the extracting endmember information for the respective multipixel reference images, there is produced a reference image endmember spectral profile matrix that specifies spectral profiles for a set of differentiated reference image endmembers;
receiving a real image representing a target in which real image endmembers are present in unknown proportions; and
searching and optimizing an abundance matrix space expressed in an unmixing formula that references together with the abundance matrix space, image information of the real image and the reference image endmember spectral profile matrix that specifies spectral profiles for the set of differentiated reference image endmembers;
wherein as a result of the searching and optimizing the abundance matrix space, there is identified a set of unmixed real image endmembers and abundances associated to the real image endmembers.

12. An apparatus comprising:
a microscope that includes multiple spectral detectors, wherein the apparatus is operative for performing the method of claim 11, wherein the apparatus is operative for performing the obtaining, with use of the microscope, the plurality of multipixel reference images, wherein respective ones of the multipixel reference images are collected with a certain reference endmember of known identity present throughout the reference target;
wherein the apparatus is further operative for performing the receiving, with use of the microscope that includes multiple spectral detectors, the real image representing the target, in which real image endmembers are present in unknown proportions;
wherein the apparatus is further operative for performing the searching and optimizing the abundance matrix space expressed in an unmixing formula that references together with the abundance matrix space, image information of the real image and the reference image endmember spectral profile matrix that specifies spectral profiles for the set of differentiated reference image endmembers, and wherein identical acquisition settings for the microscope characterize the obtaining and the receiving.

13. The method of claim 11, wherein the unmixing formula imposes a rank constraint on the abundance matrix space.

14. The method of claim 11, wherein the unmixing formula imposes a sparseness constraint on the abundance matrix space.

15. The method of claim 11, wherein the endmember extraction formula characterizes noise of respective ones of the multipixel reference images such that an endmember vector of the reference image endmember spectral profile matrix is noise reduced.

16. The method of claim 11, wherein the endmember extraction formula characterizes noise of respective ones of the multipixel reference images according to a reference image Poisson noise distribution pattern so that an endmember vector of the reference image endmember spectral profile matrix is noise reduced according to the reference image Poisson noise distribution pattern.

17. The method of claim 11, wherein the unmixing formula characterizes noise of the real image according to a real image Poisson noise distribution pattern so that the identified set of unmixed real image endmembers and abundances are noise reduced according to the Poisson noise distribution pattern.

18. The method of claim 11, wherein the certain reference endmember of known identity is a fluorophore reference endmember, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution.

19. The method of claim 11, wherein the certain reference endmember of known identity is a fluorophore reference endmember, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution, wherein the unmixing formula imposes a rank constraint on the abundance matrix space, wherein according to the rank constraint, weights are applied to candidate matrices in a manner to reduce a rank of a subset of candidate matrices evaluated by the searching and optimizing, wherein the abundance matrix space is defined by the row-fluorophores×column-pixels matrix space A, and wherein the unmixing formula applies a sparseness constraint among the rows of A, wherein the sparseness constraint is provided by the [symbol] _{2,1} norm ∥A∥_{2,1}, and wherein the unmixing formula references a sliding window matrix that defines the image information of the real image, wherein the sliding window matrix is a row=channel, column=pixels matrix, wherein the pixels dimension comprises a limited number of pixels of the real image, wherein the method includes performing iterations of searching and optimizing, and changing a location of the sliding window intermediate of iterations of the searching and optimizing, and wherein the unmixing formula characterizes real image noise of the real image as being distributed according to a real image Poisson noise distribution so that the set of unmixed real image endmembers and abundances associated to the unmixed real image endmembers are noise reduced in accordance with the real image Poisson noise distribution.

20. A method for performance of spectrally unmixing comprising:
obtaining a plurality of multipixel reference images, wherein respective ones of the multipixel reference images are collected with a certain reference endmember of known identity present throughout a reference target;
for respective ones of the plurality of multipixel reference images, extracting endmember information that includes a spectral profile of a certain endmember, wherein the extracting endmember information includes searching and optimizing an endmember spectral profile vector space expressed in an endmember extraction formula that references together with the endmember spectral profile vector space, image information of a respective multipixel reference image;
wherein as a result of performing the extracting endmember information for the respective multipixel reference images, there is produced a reference image endmember spectral profile matrix that specifies spectral profiles for a set of differentiated reference image endmembers, wherein the endmember extraction formula characterizes noise of the respective ones of the multipixel referenced images as being distributed according to a reference image Poisson noise distribution so that the reference image endmember spectral profile matrix produced as a result of performing the extracting endmember information for the respective multipixel reference images is noise reduced according to the reference image Poisson noise distribution;
receiving a real image representing a target in which endmembers are present in unknown proportions; and
unmixing the real image representing the target in dependence on the reference image endmember spectral profile matrix.
